(19) United States
(12) Patent Application Publication
(10) Pub. No.: US 2026/0129023 A1
(43) Pub. Date: May 7, 2026

(54) COMMUNICATION SYSTEM AND VEHICLE

(71) Applicant: MERCEDES-BENZ GROUP AG, Stuttgart (DE)

(72) Inventors: Daniel THOMER, Stuttgart (DE); Manuel HENLE, Nufringen (DE); Valeska MEHLER, Stuttgart (DE)

(21) Appl. No.: 19/484,583

(22) PCT Filed: May 8, 2024
(86) PCT No.: PCT/EP2024/062738

§ 371 Date: Nov. 14, 2025

(30) Foreign Application Priority Data
May 15, 2023 (DE) 10 2023 001 972.0

(51) Int. Cl. H04L 9/40

(52) U.S. Cl. CPC H04L 63/0227; H04L 63/0281; H04L 63/029

(57) ABSTRACT

A management unit of a communication system provides firewall functionality for selectively passing or blocking messages that can be exchanged between a response unit and a control device. The management unit has at least two operating modes. A different totality of messages to be passed and blocked is predetermined in each operating mode. The management unit activates one of the operating modes depending on a piece of operating mode selection information appended to a message from the response unit or the control device.

### BACKGROUND AND SUMMARY OF THE INVENTION

Exemplary embodiments of the invention relate to a communication system and to a vehicle.

Modern vehicles have a wide variety of computing units, such as control devices, a central on-board computer, a telecommunications unit, and similar. These computing units communicate both with each other and with systems external to the vehicle. Communication can take place in a wired or wireless manner. In particular, the connection of in-vehicle computing units to systems external to the vehicle provides attackers with a gateway for manipulating vehicle components. Corresponding security measures must be taken in order to prevent the introduction of malicious code into the computing units in the vehicle.

A proven and reliable method for controlling the information exchanged between two computing units is the use of so-called firewalls. A firewall is a security system comprising set rules by means of which it is determined which information packets may and may not be exchanged between the computing units. In doing so, unauthorized access is prevented. A firewall can be implemented as a software component running on a hardware component.

Since technology, and thus attack strategies and malicious code used by attackers, are constantly developing, the IT security technologies used must be adapted accordingly. If a vehicle is newly produced, the latest security requirements can be met during production. Updating the software of vehicles in use is possible by means of wireless updates or also by means of cable, for example, during a workshop visit.

However, adapting older vehicles to current security requirements is more difficult, in particular when these vehicles do not have a suitable update interface. In particular, adapting the computing units in the vehicle must remain within reasonable limits, meaning that adjusting the computing units in the vehicle should be limited to as few computing units as possible. Nevertheless, it must here be ensured that all computing units are reliably protected against attacks.

A device for securing diagnostic commands to a control device of a vehicle and a corresponding vehicle are known from US 2020/0272735 A1. The document describes the use of a firewall to filter the information exchanged between a control device and a diagnostic tester. Filtering the information to be exchanged here takes place depending on the states of the hardware installed in the vehicle and the software running on it. For example, diagnostic commands can be forwarded exclusively to specific control units, only a selection of very specific diagnostic commands can be forwarded, writing to certain memory addresses of a control device can be prevented, diagnostic commands can be suppressed when they are issued above a specified frequency, or diagnostic commands can be carried out only when the vehicle is in a specific state, such as when the vehicle is stationary, for example.

Furthermore, DE 10 2021 207 870 A1 discloses a method and a computing unit for managing diagnostic requests in a network. Here, a computing unit with firewall functionality is switched into an in-vehicle communication network between the control units installed in the vehicle and external communication interfaces. Diagnostic testers can be connected to the communication network via the external communication interfaces. The computing unit comprises a configuration file that, depending on a diagnostic request received by the computing unit and an active operating mode of the control devices connected to the computing unit, determines which diagnostic messages may and may not be exchanged between the diagnostic tester and the control units.

In addition, US 2013/0081106 A1 discloses a security device and a security system for monitoring traffic in a data bus. The security device is switched in the data bus between a connection for a tool computing unit and control devices. The security device regulates the data traffic between the tool computing unit and the control devices. Here, the security device can insert the address of a control device into a response message to the tool computing unit.

Exemplary embodiments of the present invention are directed to an improved communication system.

A generic communication system comprising a response unit external to the vehicle, at least one in-vehicle control device, and an in-vehicle management unit interposed into a communication line between the response unit and the at least one control device, wherein the management unit provides firewall functionality for selectively allowing or blocking messages that can be exchanged between the response unit and the at least one control device, is developed according to the invention in that the management unit has at least two operating modes, wherein in each operating mode a different totality of messages to be allowed through and messages to be blocked is predetermined, and wherein the management unit is set up to activate one of the operating modes depending on operating mode choice information appended to a message from the response unit or the at least one control device.

Depending on the situation, it is necessary to allow or block communication between the response unit and the control device. The response unit can be any computing unit external to the vehicle. For example, it could be a laptop, a tablet computer, a desktop computer, or similar. The response unit therefore enables a developer, a worker in vehicle production, or a mechanic during maintenance of the vehicle to address the control devices of the vehicle. Correspondingly, access to the control devices is to be granted. However, the response unit can also be used by an attacker such as a hacker in order to manipulate the control devices of the vehicle. In this case, communication between the response unit and the control units is to be restricted.

A particularly efficient method for blocking or enabling the flow of information between the response unit and the in-vehicle control devices, which is fast and requires less computing effort, is ensured by means of the communication system according to the invention. The management unit thus has at least two operating modes, which each describe a different total number of messages that are to be passed through or blocked in the corresponding operating mode. The messages that can be exchanged via the communication line can here be allocated to different message types. Different message types are characterized by a specific content and/or a specific destination address. For example, they can be commands that instruct a control unit to perform or provide a service. A control unit can then, for example, provide information in response. A message can also contain a software update, i.e., new code components to be introduced or modified in software that can be carried out by a control device. Each operating mode of the management unit here defines which messages of which type are to be passed through or blocked. Thus, it is no longer necessary for status information to be exchanged between the individual control devices and the management unit, which reduces computational effort and latency times. This also increases cybersecurity, since fewer accesses to the control devices take place. Computing units are particularly vulnerable to attacks, such as voltage glitching, for example, while processing tasks.

Here, the operating mode selection information is sent with the message itself. This further simplifies the process for decision-making regarding which messages should be allowed through and which should be blocked. Thus, the response unit also does not have to establish separate communication with the management unit and configure the management unit separately. Here, the operating mode selection information can form the entire message or just parts of it. In particular, the message comprises a header and a payload, wherein the header contains information relevant to processing the message, such as a destination address, for example, a message type, a task type, or similar, and the payload contains the relevant part of the data to be transmitted.

The operating mode selection information can also be issued by the control devices, whereby the control devices of the vehicle can also change the operating mode of the management unit.

The management unit is interposed into the communication line between the response unit and the in-vehicle control devices. Thus, it is not necessary to adjust all the control devices of the vehicle in order to improve IT security. Such centralized management of the communication traffic can be correspondingly implemented in a vehicle easily and cost-effectively.

The management unit can be dedicated hardware, i.e., for example a separate computing unit. The firewall functionality can be formed by software running on the management unit. However, the management unit itself can also be formed by software and thus embedded in a computer system, for example as a virtual machine.

An advantageous design of the communication system provides that communication taking place via the communication line is based on the UDS protocol defined by ISO 14229. UDS stands for Unified Diagnostic Services, also known as general vehicle diagnostics. In this context, the response unit is often also referred to as a tester or diagnostic tester. The communication taking place between the response unit and the control devices is then based on the so-called request-response principle, also known as the question-answer principle. The communication system according to the invention thus allows efficient and secure protection of even widely used protocols for vehicle diagnostics.

In this case, the messages exchanged between the response unit and the control devices are diagnostic messages or diagnostic commands based on the corresponding diagnostic protocol. The management unit can be a central gateway in the vehicle, which is connected to the control devices of the vehicle via individual bus systems, in particular one or more CAN buses. The strand of the communication line connecting the response unit to the management unit is then also referred to as the diagnostic bus. The message type can then be described by the UDS service. A distinction is possible using the so-called SID.

According to a further advantageous design of the communication system according to the invention, the operating mode selection information is attached to a respective message in a cryptographically secured manner. All common cryptographic methods are suitable for this purpose, such as performing signature procedures, checking certificates, performing so-called challenge-response authentication, and similar. Such cryptographic security methods are often based on the exchange of public and private keys and the calculation of secrets using hash functions. In doing so, the security of communication between the components of the communication system can be further improved. In particular, exclusively authorized computing units are able to generate corresponding messages that can also actually trigger an operating mode change. The management unit checks the authenticity of a corresponding message or the operating mode selection information by means of the aforementioned cryptographic methods and only changes the operating mode when it is also confirmed that the message originates from an authorized source.

Here, it can be provided that, to activate some certain non-safety-relevant operating modes, messages with unencrypted or cryptographically unprotected operating mode selection information are also accepted. This is the case, for example, when only one piece of information is to be read from a control device.

A further advantageous design of the communication system according to the invention further provides that the management unit is set up to automatically activate a first operating mode, to activate the operating mode specified by the operating mode selection information upon receipt of a message comprising operating mode selection information, and to automatically reactivate the first operating mode after processing at least the message. In other words, the first operating mode corresponds to a type of standard operating mode, which is thus activated most of the time. Correspondingly, messages are allowed through or blocked according to the rules underlying the first operating mode. Only when very specific, e.g., security-relevant messages are to be allowed through are these messages able to switch the management unit thanks to the attached operating mode selection information, such that a different operating mode is temporarily activated to allow the respective message to pass through. The management unit then switches back into the first operating mode. Here, a corresponding message can also specify to the management unit that not only the respective message itself is to be allowed through, but also, for example, the next x following messages. In this context, “processing the message” is to be understood to mean forwarding or blocking by the management unit.

Here, preferably, forwarding all messages is blocked in the first operating mode. In doing so, the cybersecurity of the communication system according to the invention can be further improved. Thus, the management unit generally blocks the exchange of messages between the response unit and the in-vehicle control devices. Only authorized messages, i.e., messages that comprise suitable operating mode selection information, preferably cryptographically secured operating mode selection information, can thus be forwarded.

A further advantageous design of the communication system according to the invention further provides that the management unit has a monitoring interface and is configured to provide operating information via the monitoring interface, wherein the operating information describes the operating behavior of the management unit. In doing so, users are able to understand the behavior of the management unit or the respective firewall functionality. Thus, developers, for example, can understand the reasons why a message has not been forwarded even though this should actually have been the case. Particularly advantageously, the operating information to be read out by a so-called watchdog. A watchdog is a function for detecting failures in a digital system. Correspondingly, the watchdog can initiate suitable measures in order to maintain the operation of the communication system in the event of a malfunction. For example, individual components of the communication system can be reset or restarted.

According to a further advantageous design of the communication system according to the invention, a decision logic underlying the management unit, depending on a respective operating mode, for deciding which messages are to be blocked and which are to be allowed through, is defined in the form of a decision tree. This enables the decision-making behavior of the management unit to be quickly and easily understood. Here, the various levels of the decision tree are divided depending on the message type. In the uppermost layer of the decision tree, for example, it is checked which SID a corresponding message has, whereupon messages with very specific SIDs are allowed through, messages with other SIDs are blocked, and messages with yet other SIDs are checked in the lower layers of the decision tree. In the lower layers of the decision tree, several SIDs can then be combined to form groups such that, for example, messages to very specific destination addresses are blocked or allowed through.

A further advantageous design of the communication system according to the invention further provides that, when it blocks the forwarding of a message generated by the response unit to a target control unit, the management unit is set up to respond on behalf of the target control device, wherein the management unit generates its own response message addressed to the response unit and here uses the address of the target control unit as the sender address. In doing so, the operational sequence during communication between the response unit and control device can be maintained in a particularly efficient manner. Depending on the message type, it may be necessary for the response unit to wait for a response from the target control device. However, when the management unit does not forward the corresponding message to the target control device but blocks it, then the corresponding response message will not be received, and the response unit would have to wait a disproportionately long time. However, the management unit can itself generate a response message on behalf of the target control device and send it to the response unit in order to prevent this.

Here, the management unit is preferably configured to append error information to the response message, wherein the error information contains at least an indication of at least one operating mode of the management unit. Depending on the situation, the operating behavior of the response unit can thereby be adapted. If, for example, the response unit is authorized to communicate with the control devices but has used the wrong operating mode, such that a relevant message is blocked by the management unit, then the response unit can then activate the appropriate operating mode of the management unit, whereby the messages can be forwarded to the corresponding control devices. This is the case, for example, when the response unit is used to communicate with a generic management unit without firewall functionality and to communicate with a management unit according to the invention. The response unit can thus query the implementation of the management unit and is informed of which operating modes are present. Depending on the implementation of the management unit, very different combinations of various operating modes can here also be provided. Thus, a first management unit can have a first number of operating modes, and a second management unit can have a different number of operating modes. Correspondingly, the response unit can activate the appropriate operating mode for each management unit to allow the respective message to pass through.

A vehicle according to the invention comprises at least one control device comprised in a communication system described above and one management unit comprised in such a communication system. The vehicle can be any vehicle, such as a passenger car, truck, van, bus, or similar. By comprising corresponding components of the communication system according to the invention, the cybersecurity of the vehicle according to the invention is improved in a particularly simple, efficient, and reliable manner.

Further advantageous designs of the communication system according to the invention and the vehicle also emerge from the exemplary embodiments, which are described in more detail below with reference to the Figures.

### BRIEF DESCRIPTION OF THE DRAWING FIGURES

Here are shown in:

FIG. 1 a schematic depiction of a vehicle according to the invention and a communication system according to the invention; and

FIG. 2 two decision trees configured according to different operating modes of a management unit of the communication system.

### DETAILED DESCRIPTION

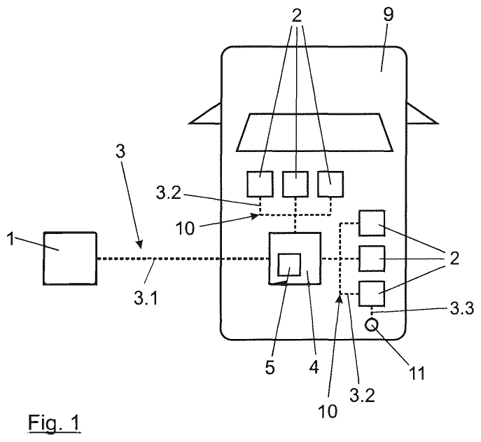

FIG. 1 shows a vehicle 9 according to the invention. The vehicle 9 comprises several control devices 2, for example an engine control device, transmission control device, ABS control device, a control device for controlling an instrument cluster, a navigation system, an infotainment system, or similar. The control devices 2 can be connected to a management unit 4 via one or more bus lines 10, for example a high-speed bus and a low-speed bus. The management unit 4 can be a dedicated computing unit or a software component running on another processing unit. The management unit 4 is also referred to as a so-called gateway.

The control devices 2 can be addressed via the management unit 4 in order to read out information, trigger a control device 2 to provide a service, and/or modify or add software components of the control devices 2. To do so, a response unit 1 external to the vehicle is connected to the corresponding control devices 2 via a communication line 3. The part of the communication line 3 between the response unit 1 and the management unit 4 is also referred to as the diagnostic bus 3.1, and the part between the management unit 4 and the control devices 2 is referred to as the type bus 3.2, wherein here the “type” stands for a category of the control devices 2 connected to the type bus 3.2, i.e. for example an infotainment bus. Furthermore, sensors 11 can be connected to a respective control device 2 via a sub-bus 3.3.

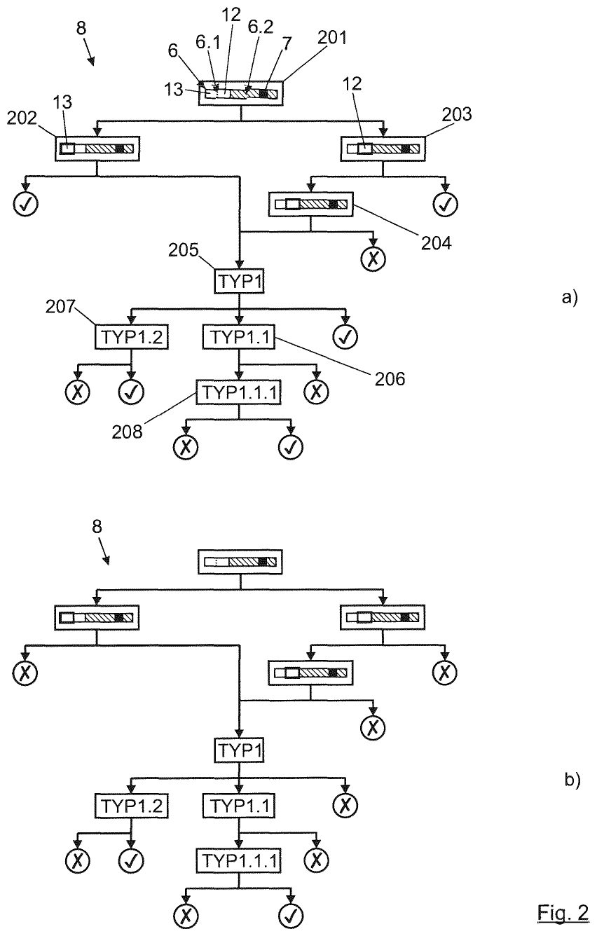

To increase cybersecurity, the management unit 4 comprises a firewall functionality 5, or provides this. The firewall functionality 5 can be provided by a software component executed on the management unit 4. The response unit 1 is used to address the respective control devices 2. Here, the management unit 4 manages the communication taking place via the communication line 3. According to an advantageous embodiment of the communication system according to the invention, this communication is based on the Unified Diagnostic Services protocol defined by ISO 14229. Here, corresponding diagnostic messages are exchanged as messages 6 shown in FIG. 2. The management unit 4 then decides which of these messages 6 are to be passed through to the respective control units 2 and which of these messages 6 are to be blocked. Analogously, the management unit 4 can also pass through or block messages 6 output by the control devices 2 to the response unit 1.

According to the invention, the management unit 4 has at least two operating modes, wherein in each operating mode, a different totality of different messages 6 is passed through or blocked. Activating a respective operating mode here takes place via operating mode selection information 7 attached to a respective message 6 (see FIG. 2). The operating mode selection information 7 can be attached to a corresponding message 6 by both the response unit 1 and a control device 2, whereby the response unit 1 and the control devices 2 can change the operating mode of the management unit 4.

The decision logic underlying a respective operating mode is depicted in FIG. 2 in the form of a decision tree 8 for two differently configured operating modes. Here, FIG. 2a) shows the configuration according to a first operating mode, and FIG. 2 b) shows the configuration according to a second operating mode. A circled check mark here corresponds to allowing messages 6 to pass through, and a circled cross corresponds to blocking the forwarding of the message 6.

In a first step 201, the management unit 4 analyzes the received message 6. Here, the message 6 is composed of a header 6.1 and payload 6.2. Here, the operating mode selection information 7 is, preferably cryptographically secured, a component of the payload 6.2. The management unit 4 activates the operating mode predetermined by the operating mode selection information 7. According to the active operating mode, various messages 6 are then forwarded or blocked. To do so, the messages 6 can be grouped according to an address part 12 and a service part 13, as indicated, for example, in the steps 202 and 203. The service part 13 describes, for example, a specific message type, i.e., for example, which service is to be provided or used by a respective control device 2 by means of the respective message 6. If the communication system according to the invention is based on the UDS protocol defined by ISO 14229, the service part 13 can, for example, be the so-called SID. Accordingly, various SIDs can be predetermined that are allowed through by the management unit 4. Corresponding filtering can be carried out based on the address part 12, wherein the address part 12 corresponds to a source or destination address of a corresponding hardware component of the communication system. In the exemplary embodiment shown in FIG. 2, the service portion 13 precedes the address part 12 in the message 6. In general, the arrangement of the service part 13 and the address part 12 could also be reversed.

Filtering the messages 6 can be performed using any number of subsequent stages. Messages 6 that are not simply allowed through in step 203 can then be further checked, for example, in a subsequent step 204. A first subset of these messages 6 can then be blocked, and a further subset, referred to here as TYP1, can be further checked in step 205. This subset then comprises, for example, messages that provide very specific services for very specific destination addresses. From the subset TYP1, further subsets TYP1.1 and TYP1.2 can then be formed in steps 206 and 207. In step 208, a further subset, referred to here as TYP1.1.1, can also be formed from such a subset.

According to FIG. 2b), a different operating mode of the management unit 4 is active, such that in each case different messages 6 can be allowed to pass through or blocked.

The communication system according to the invention can be integrated particularly easily and thus cost-effectively into existing vehicles. Only one component, namely the management unit 4, needs to be adjusted. The communication system thus enables the reuse of existing technologies. By managing or filtering the communication taking place via the communication line 3, cybersecurity is improved. Reliable access to the control devices 2 for authorized users is here ensured in a simple manner. Thus, appropriately authorized users can quickly and easily configure the management unit 4 by transmitting a corresponding message 6, containing a piece of corresponding operating mode selection information 7, in such a way that the required access to the control units 2 can be carried out.

Although the invention has been illustrated and described in detail by way of preferred embodiments, the invention is not limited by the examples disclosed, and other variations can be derived from these by the person skilled in the art without leaving the scope of the invention. It is therefore clear that there is a plurality of possible variations. It is also clear that embodiments stated by way of example are only really examples that are not to be seen as limiting the scope, application possibilities or configuration of the invention in any way. In fact, the preceding description and the description of the figures enable the person skilled in the art to implement the exemplary embodiments in concrete manner, wherein, with the knowledge of the disclosed inventive concept, the person skilled in the art is able to undertake various changes, for example, with regard to the functioning or arrangement of individual elements stated in an exemplary embodiment without leaving the scope of the invention, which is defined by the claims and their legal equivalents, such as further explanations in the description.

1-10. (canceled)

11. A communication system comprising:
a response unit external to a vehicle;
at least one in-vehicle control device in the vehicle; and
an in-vehicle management unit in the vehicle and interposed in a communication line between the response unit and the at least one control device,
wherein the management unit is configured to provide firewall functionality to selectively pass or block messages exchanged between the response unit and the at least one control device,
wherein the management unit is configured with at least two operating modes, wherein a different totality of messages to be passed and blocked is predetermined in each of the at least two operating modes, and
wherein the management unit configured to activate one of the operating modes depending on a piece of operating mode selection information appended to a message from the response unit or the at least one control device.

12. The communication system of claim 11, wherein communication via the communication line is based on UDS protocol defined by ISO 14229.

13. The communication system of claim 11, wherein the operating mode selection information is appended to a respective message in a cryptographically secured manner.

14. The communication system of claim 11, wherein the management unit is configured to:
automatically activate a first operating mode;
activate an operating mode specified by the operating mode selection information after receiving the message comprising operating mode selection information; and
automatically reactivate the first operating mode after processing the message.

15. The communication system of claim 14, wherein forwarding all messages is blocked in the first operating mode.

16. The communication system of claim 11, wherein the management unit comprises a monitoring interface and is configured to provide operating information via the monitoring interface, wherein the operating information describes operating behavior of the management unit.

17. The communication system of claim 11, wherein a decision tree defines decision logic the management unit uses to decide, depending on a respective operating mode, which messages are to be blocked by the firewall and which are to be allowed through the firewall.

18. The communication system of claim 11, wherein the management unit is configured to:
respond on behalf of a target control device of the at least one in-vehicle control device when the management unit blocks forwarding of a message generated by the response unit to a target control unit, by generating its own response message directed to the response unit and using an address of a target control unit as a sender address.

19. The communication system of claim 18, wherein the management unit is configured to:
attach error information to the response message, wherein the error information contains at least one indication of at least one operating mode of the management unit.

20. A vehicle comprising:
a communication system, which comprises
a response unit external to a vehicle;
at least one in-vehicle control device in the vehicle; and
an in-vehicle management unit in the vehicle and interposed in a communication line between the response unit and the at least one control device,
wherein the management unit is configured to provide firewall functionality to selectively pass or block messages exchanged between the response unit and the at least one control device,
wherein the management unit is configured with at least two operating modes, wherein a different totality of messages to be passed and blocked is predetermined in each of the at least two operating modes, and
wherein the management unit configured to activate one of the operating modes depending on a piece of operating mode selection information appended to a message from the response unit or the at least one control device.
